(19) United States
(12) Patent Application Publication
(10) Pub. No.: US 2021/0224903 A1
(43) Pub. Date: Jul. 22, 2021

(54) VERTICAL GLOBAL ENERGY ONLINE TRADING PLATFORM

(71) Applicant: THE SOLAR GENERATION COMPANY LLC, Santa Monica, CA (US)

(72) Inventors: Alexander MATHIESEN-OHMAN, Marstrand (SE); Marek KOWALSKI, Zielonki (PL)

(21) Appl. No.: 16/755,305

(22) PCT Filed: Oct. 11, 2018
(86) PCT No.: PCT/US2018/055385

§ 371 Date: Apr. 10, 2020

Related U.S. Application Data
(60) Provisional application No. 62/571,129, filed on Oct. 11, 2017.

(51) Int. Cl. G06Q 40/04; G06Q 50/06; G06Q 10/06; G06Q 10/04; G06Q 20/06; G05B 13/02; H02J 3/00; H02J 3/32; H02J 3/38

(52) U.S. Cl. CPC G06Q 40/04; G06Q 20/381; G06Q 10/06315; G06Q 10/04; G06Q 20/0655; G06Q 10/06312; G06Q 10/06313; G05B 13/0265; H02J 3/003; H02J 3/004; H02J 3/008; H02J 3/32; H02J 3/381; G06Q 2220/00; G06Q 50/06

(57) ABSTRACT

One embodiment provides method comprising forecasting energy consumption of a consumer located in a first geographical location utilizing an artificial intelligence (AI) smart device, forecasting energy production in an environment of the consumer utilizing the AI smart device, and balancing the energy consumption with the energy production utilizing the AI smart device. The balancing comprises trading energy on an online energy trading platform with one or more entities located in one or more other geographical locations utilizing crypto commodity.

### CROSS-REFERENCE TO RELATED APPLICATIONS

The present application claims priority to U.S. Provisional Patent Application No. 62/571,129, filed on Oct. 11, 2017, which is hereby incorporated by reference in its entirety.

### TECHNICAL FIELD

One or more embodiments relate generally to energy production and energy trading, and in particular, a vertical global energy online trading platform.

### BACKGROUND

The electric power industry encompasses the generation (i.e., production), distribution, and sale of electric power/electricity to the general public and industry. Reliable and economical electric power has become an essential aspect for normal operation of all elements of developed economies and human civilization.

### SUMMARY

One embodiment provides method comprising forecasting energy consumption of a consumer located in a first geographical location utilizing an artificial intelligence (AI) smart device, forecasting energy production in an environment of the consumer utilizing the AI smart device, and balancing the energy consumption with the energy production utilizing the AI smart device. The balancing comprises trading energy on an online energy trading platform with one or more entities located in one or more other geographical locations utilizing crypto commodity.

Another embodiment provides a system comprising a memory device configured to store instructions and at least one hardware processor configured to execute the instructions. The instructions include forecasting energy consumption of a consumer located in a first geographical location, forecasting energy production in an environment of the consumer, and balancing the energy consumption with the energy production. The balancing comprises trading energy on an online energy trading platform with one or more entities located in one or more other geographical locations utilizing crypto commodity.

One embodiment provides a computer program product comprising a computer readable storage device having program instructions embodied therewith, the program instructions readable by a processor device to cause the processor device to forecast energy consumption of a consumer located in a first geographical location, forecast energy production in an environment of the consumer, and balance the energy consumption with the energy production by trading energy on an online energy trading platform with one or more entities located in one or more other geographical locations utilizing crypto commodity.

These and other features, aspects and advantages of the one or more embodiments will become understood with reference to the following description, appended claims and accompanying figures.

### BRIEF DESCRIPTION OF THE DRAWINGS

FIG. 1 illustrates an example computing architecture for implementing a vertical global energy online trading platform, in accordance with an embodiment of the invention;

FIG. 2 illustrates an example online energy trading system, in accordance with an embodiment of the invention;

FIG. 3A illustrates an example energy forecast system, in accordance with an embodiment of the invention;

FIG. 3B illustrates an example consumer environment, in accordance with an embodiment of the invention;

FIG. 4 illustrates an example vertical supply chain, in accordance with an embodiment of the invention;

FIG. 5 illustrates an example distributed system, in accordance with an embodiment of the invention;

FIG. 6 is an example merit order curve model;

FIG. 7 is an example graph illustrating Day-Ahead Market prices;

FIG. 8 is an example map illustrating regulated energy markets and deregulated energy markets in the US;

FIG. 9 illustrates an example business model for trading energy between participants located in different geographical locations utilizing the online energy trading system, in accordance with an embodiment of the invention;

FIG. 10 illustrates an example table illustrating performance of a price arbitrage model using historical prices for the Finnish market in April 2017, in accordance with an embodiment of the invention;

FIG. 11 illustrates an example table illustrating differences between yearly cost of the same amount of energy bought and sold during lowest and highest peaks on weekdays and weekends, in accordance with an embodiment of the invention;

FIG. 12 illustrates an example table illustrating an average energy consumption profile of an average residential household in Helsinki, in accordance with an embodiment of the invention;

FIG. 13 illustrates an example table illustrating an average energy production profile of an installation of photovoltaic (PV) panels (“PV installation”) on a rooftop of a residential household that is configured to produce 1 kWp, in accordance with an embodiment of the invention;

FIG. 14 illustrates an example table illustrating balance of cost and revenues for an average residential household in Helsinki with a PV installation with a combined nominal power of 6,09 kWp, in accordance with an embodiment of the invention;

FIG. 15 illustrates an example table illustrating difference in performance of a PV installation with nominal power of 1 kWp in Las Vegas and Helsinki, in accordance with an embodiment of the invention;

FIG. 16 illustrates an example table illustrating average monthly energy production of a PV installation in Las Vegas and profits that can be earned from the PV installation, in accordance with an embodiment of the invention;

FIG. 17 is a flowchart for an example process for implementing a vertical global energy online trading platform, in accordance with an embodiment of the invention; and

FIG. 18 is a high-level block diagram showing an information processing system comprising a computer system useful for implementing the disclosed embodiments.

### DETAILED DESCRIPTION

The following description is made for the purpose of illustrating the general principles of one or more embodiments and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

One or more embodiments relate generally to energy production and energy trading, and in particular, a vertical global energy online trading platform. One embodiment provides method comprising forecasting energy consumption of a consumer located in a first geographical location utilizing an artificial intelligence (AI) smart device, forecasting energy production in an environment of the consumer utilizing the AI smart device, and balancing the energy consumption with the energy production utilizing the AI smart device. The balancing comprises trading energy on an online energy trading platform with one or more entities located in one or more other geographical locations utilizing crypto commodity.

Another embodiment provides a system comprising a memory device configured to store instructions and at least one hardware processor configured to execute the instructions. The instructions include forecasting energy consumption of a consumer located in a first geographical location, forecasting energy production in an environment of the consumer, and balancing the energy consumption with the energy production. The balancing comprises trading energy on an online energy trading platform with one or more entities located in one or more other geographical locations utilizing crypto commodity.

One embodiment provides a computer program product comprising a computer readable storage device having program instructions embodied therewith, the program instructions readable by a processor device to cause the processor device to forecast energy consumption of a consumer located in a first geographical location, forecast energy production in an environment of the consumer, and balance the energy consumption with the energy production by trading energy on an online energy trading platform with one or more entities located in one or more other geographical locations utilizing crypto commodity.

For expository purposes, the term “energy” as used in this specification generally refers to any form of renewable energy such as, but not limited to, solar energy, wind energy, hydro energy, thermal energy, etc. The terms “energy”, “power”, and “electricity” are used interchangeably in this specification.

For expository purposes, the term “consumer” as used in this specification generally refers to any individual (e.g., a tenant, a property owner, etc.), any group of individuals (e.g., a family, a community, etc.), or any entity (e.g., an organization, an institution, etc.) that consumes energy. The terms “consumer” and “end-customer” are used interchangeably in this specification.

For expository purposes, the term “consumer environment” as used in this specification generally refers to an environment occupied by a consumer such as, but not limited to, a household (e.g., a house, an apartment, etc.), a place of business for an organization (e.g., a building, etc.), a school, etc. The terms “household” and “residential household” are used interchangeably in this specification.

Since the Industrial Revolution, electricity supply has been a major governmental responsibility. Year by year, human civilization consumes more and more electricity and the rate of growth of that consumption accelerates. Human civilization is constantly looking for new and improved ways to fulfill its growing thirst for power or risk a lapse in global development.

Unlike water, gas, food, and other necessities, there is no effective way to store electricity for later use. Battery cell storage is very expensive and has limited capacity. Effectively for every appliance running at any given moment something must be generating that electricity at the same time. This makes it necessary for operators of local energy grids to seek and maintain balance between production and consumption of power. This is accomplished in different ways in different parts of the world. For example, some governments rely on central planning and direct control of infrastructure by governmental bodies (i.e., regulated energy markets). As another example, other governments decide to open energy markets to multiple actors (i.e., deregulated energy markets) and construct economic rules which incentive behaviors leading to balance.

Almost all electricity produced today is generated in industrial-sized power plants. For security and ecological concerns, the majority of power generators are located far away from large cities which consume electricity. This adds another layer of complexity for operators of local energy grids who need to ensure an infrastructure for transportation of power. The infrastructure not only has to work on a normal day, it also has to take into account possible energy consumption spikes, such as a local heat wave or extreme cold spell, as well as energy production spikes, such as a windy day in an area with a lot of wind generators.

Embodiments of the invention provide a system and method for decentralizing energy generation (i.e., energy production). One embodiment allows for production of solar energy close to a consumption point using one or more installations of solar panels (e.g., photovoltaic (PV) panels), resulting in huge savings on costly infrastructure as such installations only require a modest initial investment. Further, the installations generate free power after the initial investment is paid off

Decentralization of energy generation ensures a continuous supply of energy because unlike conventional energy generation solutions, as it is not vulnerable to failure of central sections of a local energy grid. Further, decentralization has a positive economic effect as it allows consumers to own parts of the infrastructure they depend on.

One issue that arises with utilizing solar energy is that solar energy is only generated during the day and the generation is dependent on the weather. As a result, the energy consumption needs of a single household may include spikes that cannot be fulfilled with the production from a single installation of a solar panel. Embodiment of the invention address this issue on multiple levels. For example, on the local level, one embodiment of the invention allows for whole communities of solar plants to trade with each other to balance varying energy consumption needs. Excess power is exchanged for a crypto commodity on the public Ethereal blockchain and can be reclaimed later for the same amount of electricity. From the perspective of an end-customer, the Ethereal blockchain is analogous to an infinite-sized battery. One embodiment of the invention further provides an artificial intelligence (AI) unit for controlling use of real batteries in a household with a capacity of about 5-15 kWh per household, allowing for better trading decisions to be made from the point of view of a community.

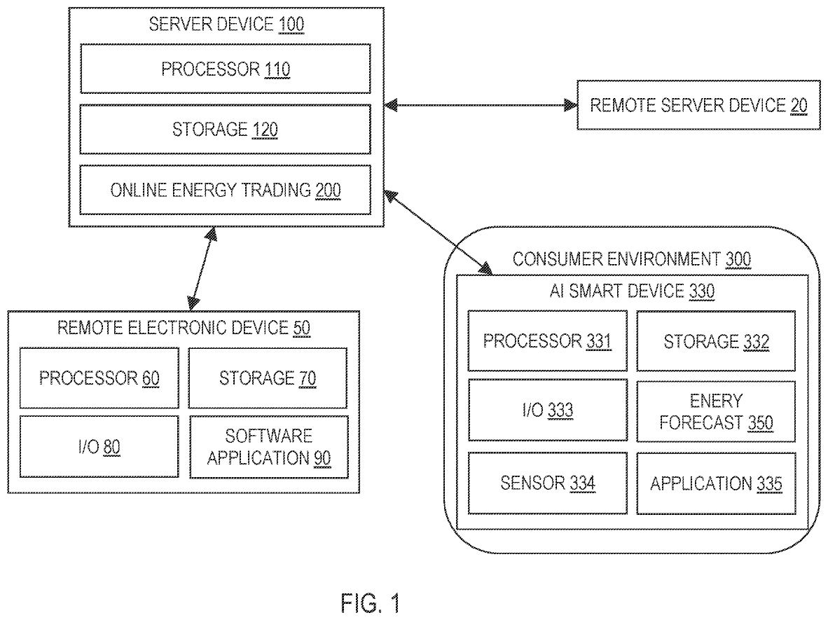

FIG. 1 illustrates an example computing architecture for implementing a vertical global energy online trading platform, in accordance with an embodiment of the invention. In one embodiment, a vertical global energy online trading platform is implemented on a server device 100. For example, in one embodiment, the server device 100 comprises computation resources such as, but not limited to, one or more processor units 110 and one or more storage units 120. One or more applications execute/operate on the server device 100 utilizing the computation resources of the server device 100.

In one embodiment, the one or more applications on the server device 100 include an online energy trading system 200 configured to implement a vertical global energy online trading platform in which energy (e.g., solar energy) generated in a geographical location is converted to a crypto commodity and its value transported through the Ethereal blockchain, allowing the energy to be bought back in a different geographical location with higher energy consumption needs. The system 200 facilitates global distribution and trading of crypto commodity used for buying/selling energy, thereby allowing decentralization of energy generation and providing energy independence to consumers.

For example, during winter months when local solar energy production is not sufficient to cover a community's needs, the system 200 allows for a consumer to purchase solar energy harvested in different geographical locations that are not connected to a local infrastructure for transporting electricity. The system 200 converts the solar energy to a crypto commodity and transports its value through the Ethereal blockchain so that it can be used to buy the solar energy back on an open energy market with higher energy consumption needs. This facilitates placement of solar plants in geographical locations with a better solar index.

The system 200 allows end-customers and utility providers to exploit price differences between countries. For example, in one embodiment, the system 200 is configured to convert 1 kWh of solar energy harvested in the US into crypto commodities which are then sold for 15 kWh of energy to a consumer in Scandinavia.

In one embodiment, the system 200 is configured to exchange data with one or more other devices over a connection (e.g., a wireless connection such as a Wi-Di connection or a cellular data connection, a wired connection, or a combination of the two). For example, in one embodiment, the system 200 is configured to exchange data with, but not limited to, one or more of the following: a remote electronic device 50, a remote server device 20, or an AI smart device 330 deployed in a consumer environment 300.

In one embodiment, a remote electronic device 50 and/or a remote server device 20 is an external data source.

In one embodiment, the system 200 is accessed or utilized by one or more online services deployed/hosted on a remote server device 20. For example, in one embodiment, the system 200 is configured to exchange data with one or more other systems 200 executing/operating on one or more remote server devices 20 located in a one or more different geographical locations to facilitate distribution and trading of energy worldwide.

In one embodiment, a remote electronic device 50 is equipped with one or more computation resources such as, but not limited to, one or more processor units 60 and one or more storage units 70. One or more applications execute/operate on a remote electronic device 50 utilizing one or more computation resources of the remote electronic device 50 such as, but not limited to, one or more software applications 90 loaded onto or downloaded to the remote electronic device 50.

In one embodiment, a remote electronic device 50 comprises one or more I/O units 80 integrated in or coupled to the remote electronic device 50, such as a keyboard, a keypad, a touch interface, a display screen, etc. In one embodiment, a user (e.g., a consumer) utilizes an I/O unit 80 of a remote electronic device 50 to configure one or more user preferences, configure one or more parameters (e.g., a pre-defined threshold), enter input, etc.

In one embodiment, a remote electronic device 50 comprises any type of electronic device such as, but not limited to, a desktop computer, a smart television, a smart car, a mobile device (e.g., a smart phone, a tablet, a laptop, etc.), a wearable device (e.g., a smart watch), an Internet of Things (Ito) device, etc.

In one embodiment, the system 200 is accessed or utilized by one or more software applications 90 operating on a remote electronic device 50. For example, in one embodiment, a software application 90 (e.g., a mobile app, a web browser, etc.) on the remote electronic device 50 utilizes the system 200 to purchase energy utilizing crypto commodities.

In one embodiment, an AI smart device 330 is equipped with one or more computation resources such as, but not limited to, one or more processor units 331 and one or more storage units 332. One or more applications execute/operate on an AI smart device 330 utilizing one or more computation resources of the AI smart device 330 such as, but not limited to, an energy forecast system 350 configured to forecast energy consumption needs of a consumer (e.g., household consumption), forecast energy production of one or more energy production units utilized by the consumer, and balance energy consumption needs of the consumer by trading energy on the system 200. For example, in one embodiment, if the energy forecast system 350 forecasts energy consumption needs of the consumer will exceed energy production of the one or more energy production units, the energy forecast system 350 is configured to autonomously purchase energy from the system 200 utilizing crypto commodities issued/sold to the consumer.

In one embodiment, an AI smart device 330 is a standalone household saltbox with the energy forecast system 350 integrated/embedded in the saltbox.

In one embodiment, an AI smart device 330 comprises one or more I/O units 333 integrated in or coupled to the AI smart device 330, such as a keyboard, a keypad, a touch interface, a display screen, etc. In one embodiment, a user (e.g., a consumer) utilizes an I/O unit 333 of an AI smart device 330 to configure one or more user preferences, configure one or more parameters (e.g., a pre-defined threshold), enter input, etc.

In one embodiment, an AI smart device 330 comprises one or more optional sensor units 334 integrated in or coupled to the AI smart device 330, such as a GPS, an image sensor (e.g., a camera), a microphone, a temperature sensor, etc. In one embodiment, the system 200 utilizes at least one sensor unit 334 of an AI smart device 330 to capture context information related to a consumer/consumer environment 300, such as a GPS for location data (e.g., location coordinates), an image sensor for image/video data (e.g., a live video capture or a photograph of the consumer and/or the consumer environment), a microphone for ambient noise, a temperature sensor for temperature of the consumer environment, etc.

In one embodiment, an AI smart device 330 comprises one or more optional software applications 335 loaded onto or downloaded to the remote electronic device 50 to perform one or more additional smart functions/services such as, but not limited to, home automation (e.g., automatically powering on/off one or more consumer devices in the consumer environment at pre-determined times), home security (e.g., monitoring security of the consumer environment via one or more security cameras, etc.), insurance and financial services (e.g., automatic payment of utility bills, etc.), energy conservation (e.g., conserving energy in the consumer environment by powering off lights and putting to sleep consumer devices when supply of energy available in the consumer environment is low). In one embodiment, the one or more additional smart functions/services are customized/tailored based on the needs of the consumer and/or services offered by a utility provider or re-seller of energy.

In one embodiment, the server device 200 is part of a cloud computing environment.

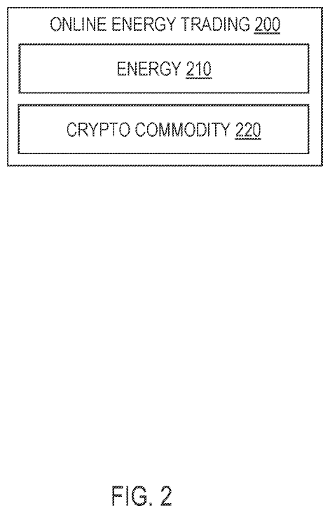

FIG. 2 illustrates an example online energy trading system 200, in accordance with an embodiment of the invention. In one embodiment, the system 200 comprises an energy unit 210 configured to facilitate energy trade, and a crypto commodity unit 220 configured to facilitate the energy trade using crypto commodities (e.g., Ebert tokens/credits), as described in detail later herein.

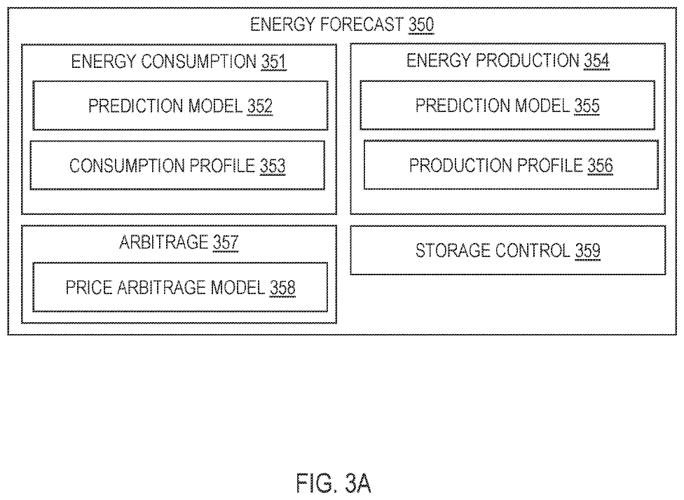

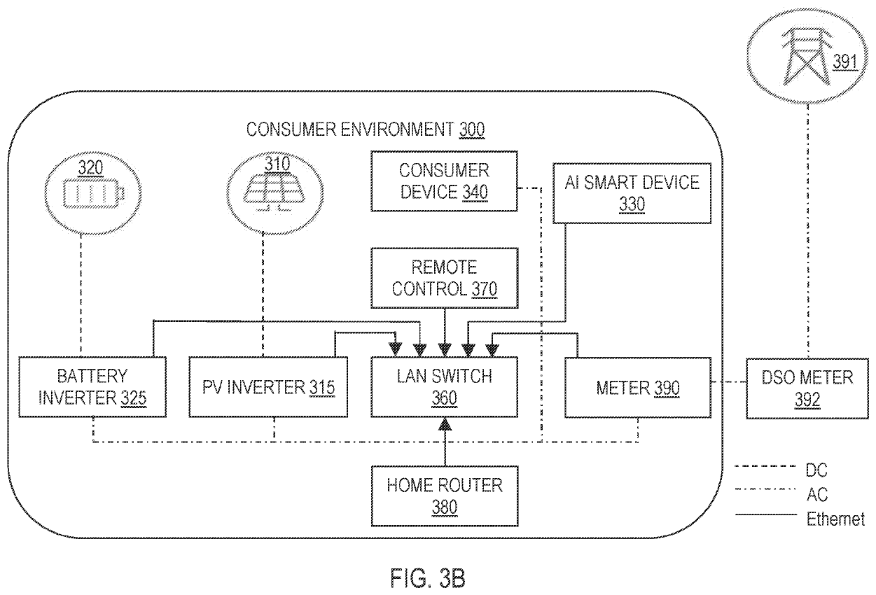

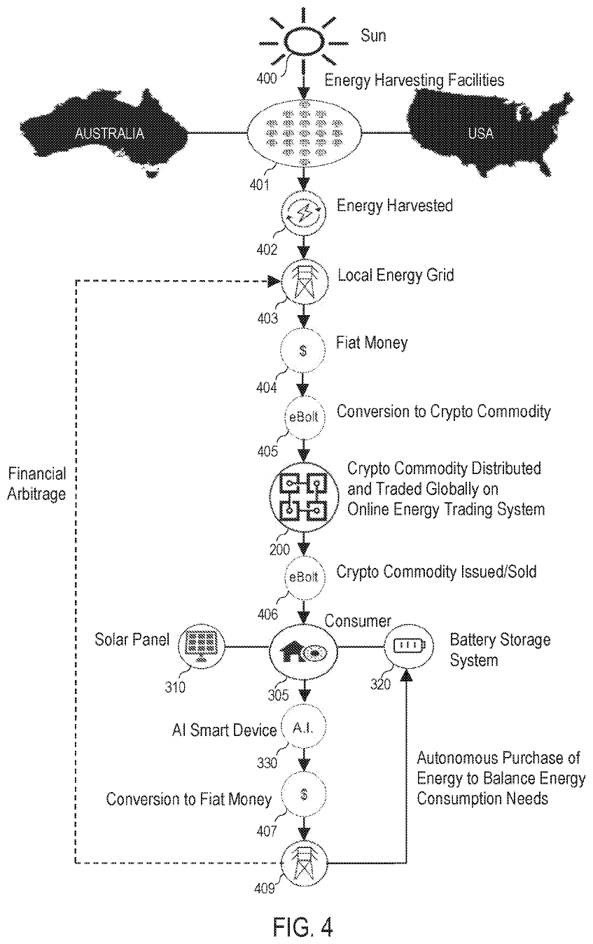

FIG. 3A illustrates an example energy forecast system 350, in accordance with an embodiment of the invention. FIG. 3B illustrates an example consumer environment 300, in accordance with an embodiment of the invention. In one embodiment, a consumer environment 300 of a consumer 305 (FIG. 4) comprises one or more energy production units 310 (e.g., PV panels) for local energy production, one or more battery storage systems 320 for local energy storage, one or more consumer devices 340 utilized by the consumer 305 (e.g., household electronic devices, such as a television, a computer, etc.), and an AI smart device 330 including an energy forecast system 350.

In one embodiment, the energy forecast system 350 comprises an energy consumption unit 351 configured to forecast/predict energy consumption needs of a consumer 305 utilizing a trained prediction (i.e., predictive) model 352. In one embodiment, the prediction model 352 is trained to consider factors such as, but not limited to, temperature, day of the week, public holidays, and average metered consumption over the last 3 hours. Predictions from the prediction model 352 are based on weather forecast and are propagated forward to cover the full range of the next day.

In one embodiment, in a training phase, a prediction model is trained to predict energy consumption needs of a consumer 305 based on training data including historical energy consumption data of the consumer 305. In one embodiment, different machine learning techniques are applied to train the prediction model based on the training data such as, but not limited to, regression-based techniques (e.g., Stochastic Gradient Descent, etc.), density-based techniques (e.g., k-nearest neighbor, local outlier factor, etc.), subspace and correlation-based outlier detection for high-dimensional data techniques, and support vector machines. After training, the resulting prediction model is deployed as a prediction model 352 for use in a deployment phase to predict energy consumption needs of a consumer 305.

In one embodiment, the energy consumption unit 351 is configured to maintain one or more energy consumption profiles 353, wherein each energy consumption profile 353 is indicative of energy consumption needs of an individual user or an entire household.

In one embodiment, the energy forecast system 350 comprises an energy production unit 354 configured to forecast/predict energy production of one or more energy production units 310 (e.g., solar panels) in a consumer environment 300 utilizing a trained prediction (i.e., predictive) model 355. For example, in one embodiment, the one or more energy production units 310 comprise an installation of PV panels (“PV installation”) with nominal power ranging between 4,06 kWp and 17,98 kWp depending on available space on a rooftop.

Nominal power of a PV installation is specified in kWp (power in kilowatts at peak of production) and is based on effectiveness of the panels and a number of panels installed, wherein the number of panels installed is limited by available space on a rooftop.

In one embodiment, the one or more energy production units 310 provide a combined nominal power of 6.1 kWp.

The most effective configuration for a PV installation is a rooftop facing south) (0°). In reality, however, there will be a distribution of different geometric rooftop orientations.

The prediction model 355 is trained to predict energy production of each PV installation on an hourly basis. In one embodiment, the prediction model 355 is trained to consider factors such as, but not limited to, constant factors like nominal power, geometrical roof orientation and geographic location, and variable factors that dynamically change based on time of day and weather (e.g., cloudiness) like isolation. Predictions from the prediction model 355 are based on next-day weather forecasts.

In one embodiment, in a training phase, a prediction model is trained to predict energy production of an energy production unit 310 based on training data including historical energy production data of the energy production unit 310. In one embodiment, different machine learning techniques are applied to train the prediction model based on the training data such as, but not limited to, regression-based techniques (e.g., Stochastic Gradient Descent, etc.), density-based techniques (e.g., k-nearest neighbor, local outlier factor, etc.), subspace and correlation-based outlier detection for high-dimensional data techniques, and support vector machines. After training, the resulting prediction model is deployed as a prediction model 355 for use in a deployment phase to predict energy production of an energy production unit 310.

In one embodiment, the energy production unit 354 is configured to maintain one or more energy production profiles 356, wherein each energy production profile 356 is indicative of energy production of the one or more energy production units 310.

In one embodiment, one or more battery storage systems 320 are utilized in a consumer environment 300. Combining battery storage systems 320 with energy production units 310 (e.g., PV panels) allows for storage of excess energy produced by the energy production units 310 for later use. For example, when the sun goes down and PV panels stop producing electricity, power is obtained from the battery storage systems 320 instead of pulling it from a local energy grid 391. As another example, in the event of a spike of energy consumption needs, the battery storage systems 320 can amortize the spike by supplying the consumer environment 300 with extra kilowatts needed instead of pulling high-priced power from a local energy grid 391 (i.e., peak shaving), thereby allowing the consumer environment 300 to reduce a size of its fuses and apply for a lower tariff.

A battery storage system 320 includes a battery management system (BMS) for controlling storage of energy in the battery storage system 320. For example, if energy production of one or more energy production units 310 in a consumer environment 300 is higher than energy consumption needs of a consumer 305 (i.e., there is an energy surplus), the BMS is configured to invoke/trigger one of the following actions with respect to surplus energy produced by the energy production units 310: (1) charge the battery storage system 320 with the surplus energy if the battery storage system 320 is not fully charged, or (2) sell the surplus energy to a local energy grid 391. If the energy production is less than the energy consumption needs instead (i.e., there is an energy deficit), the BMS is configured to invoke/trigger one of the following actions with respect to obtaining extra energy required to meet the energy consumption needs: (1) discharge the extra energy required from the battery storage system 320 if the battery storage system 320 is not empty, or (2) pull the extra energy required from a local energy grid 391. The BMS generates savings for the consumer 305 by minimizing the amount of energy purchased from the local energy grid 391.

Pulling energy from the local energy grid 391 during peak energy consumption demand may result in payment of higher energy prices as energy prices are adjusted hourly. To overcome this issue, the energy forecast system 350 comprises an arbitrage unit 357 configured to perform price arbitrage on daily fluctuations of energy prices utilizing a price arbitrage model 358. As described in detail later herein, the arbitrage unit 357 is configured to optimize costs of purchasing energy from the point of view of an energy supplier; the resulting savings are transferred down to the consumer 305 by lowering the energy rates the consumer 305 pays.

In one embodiment, the energy forecast system 350 comprises a storage control unit 359 configured to override a BMS of a battery storage system 320, as described in detail later herein.

In one embodiment, the consumer environment 300 further comprises one or more of the following components: a PV inverter 315 connected to the one or more energy production units 310, a battery inverter 325 connected to the one or more battery storage systems 320, a remote control unit 370, and a meter 390 connected to an external Distribution System Operator (DSO) meter 392 for a local energy grid 391. In one embodiment, the AI smart device 3300 and the components are connected on a home network including a LAN switch 360 and a home router 380 and communicate over Ethernet. In one embodiment, electrical signals (e.g., AC, DC) are exchanged between various components, as shown in FIG. 3B.

The remote control unit 370 is connected directly to the PV inverter 315 and the battery inverter 325 (e.g., using the Modulus interface) and provides for live preview of energy consumption and energy production of energy. Together with the storage control unit 359, the remote control unit 370 can takes control of the one or more battery storage systems 320 and override its BMS to make decisions about when to charge and discharge the battery storage systems 320.

In one embodiment, the remote control unit 370 is Wi-Di enabled and includes a multi-functional end-user mobile application.

In one embodiment, the AI smart device 330 is pre-installed with a mobile application GUI that serves as an installation wizard and a customer service platform for household related services.

In one embodiment, the energy forecast system 350 is configured to collect all data generated by all components and energy usage data, and include the data collected to individual profiles (e.g., consumption profile 353, production profile 356).

In one embodiment, for consumers 305, pricing of energy is subscription based, wherein the monthly subscription fee is based on the size of the consumer 305 and assumed energy consumption.

FIG. 4 illustrates an example vertical supply chain, in accordance with an embodiment of the invention. In one embodiment, the system 200 is integrated in a vertical supply chain combining location-optimized energy generation (e.g., geographical locations that are suitable for solar panels, solar thermal collectors or other means of converting sunlight into useful energy), instant peer-to-peer transactions, and financial arbitrage between regulated and non-regulated energy markets.

As shown in FIG. 4, in one embodiment, the vertical supply chain includes an infrastructure comprising different energy harvesting facilities 401 located in different geographical locations worldwide (e.g., USA, Australia, etc.). Each energy harvesting facility 401 includes one or more means for harvesting renewable energy 402 such as, but not limited to, solar panels for harvesting solar energy, wind generators for harvesting wind energy, etc. For example, as shown in FIG. 4, an energy harvesting facility 401 is a solar plant including installations of solar panels for converting sunlight from the sun 400, a source of renewable energy, into solar energy.

As shown in FIG. 4, renewable energy 402 harvested by an energy harvesting facility 401 is purchased by a utility provider (e.g., the Los Angeles Department of Water and Power, etc.) and distributed as electricity on a local energy grid 403 operated/controlled by the utility provider. Payment of the renewable energy 402 purchased is made using fiat money 404 such as, but not limited to, fiat currency (e.g., USD, AUD, EUR, etc.).

As shown in FIG. 4, the system 200 is configured to convert the renewable energy 402 purchased by the utility provider to a crypto commodity 405. In one embodiment, the renewable energy 402 is converted to one or more Ebert tokens/credits. Ebert is a crypto commodity created by the Applicant, the Solar Generation Company LLC (“the Solar Generation”) for use in global transactions. One Ebert token/credit is equivalent to 1 kWh of electricity. The system 200 is configured to exchange/trade Ebert tokens/credits for one or more other types of crypto commodity, such as, but not limited to, Ether (ETH), the cryptocurrency for the Ethereum blockchain. eBOLT tokens/credits are compliant with the ERC20 token interface, a common interface. eBOLT tokens/credits can be freely exchanged between parties and can be used in third-party contracts designed to work with the ERC20 token interface.

In one embodiment, the system 200 utilizes a SaleOffer contract for exchanging eBOLT tokens/credits for ETH.

As shown in FIG. 4, the system 200 is configured to issue/sell crypto commodity 406 to one or more consumers 305 in one or more balancing groups, wherein each balancing group comprises a collection of consumers located within the same geographical location (e.g., a collection of households in Scandinavia). A consumer 305 (e.g., a household) can utilize crypto commodity 406 issued/sold to the consumer 305 to purchase energy to balance energy consumption needs of the consumer 305.

In one embodiment, a consumer 305 has one or more energy production units 310 (e.g., solar panels), one or more battery storage systems 320, and an AI smart device 330. If the AI smart device 330 forecasts that energy consumption needs of the consumer 305 will exceed amount of energy available to the consumer 305 (e.g., amount of energy produced by the energy production units 310), the AI smart device 330 is configured to convert crypto commodity 406 issued/sold to the consumer 305 into fiat money 407 that is then used to purchase electricity from a local energy grid 409 within the same geographical location as the consumer 305. The system 200 and the AI smart device 330 provide the consumer 305 with energy independence, enabling the consumer 305 to autonomously purchase energy to balance energy consumption needs of the consumer 305.

Unlike conventional energy generation solutions that utilize large-scale power generators (e.g., industrial-sized power plants), installation and operating costs of solar panels is significantly less. For example, installation of solar panels require only an upfront initial investment, and the operating costs are minimal as no extra fuel is needed (only maintenance of the solar panels is needed). Further, if enough solar panels are installed, the installation results in pure profit with minimal operational costs after the initial investment is paid off

Further, unlike conventional energy generation solutions, the system 200 leverages existing energy markets, financial systems and the Ethereum blockchain to make it irrelevant where energy 402 is generated/produced. As long as there is a consumer willing to purchase energy 402 harvested by the energy harvesting facilities 401, the system 200 is configured to convert the renewable energy 402 to a crypto commodity 406 that can be purchased to distribute the renewable energy 402 on-demand to a different local energy grid in the different geographical location where there is a higher energy consumption need. The combination of energy markets, financial systems and the Ethereum blockchain operate as substitutes for physical global power lines that currently do not exist.

In one embodiment, the entire vertical supply chain, from energy generation to energy consumption, is owned by a single entity, such as the Solar Generation, thereby removing incurring any intermediary costs along the supply chain.

In one embodiment, end-customers and utility providers pay a subscription fee (e.g., a monthly subscription fee) to utilize the services of the system 200. The entity can use subscription fees collected to pay off interest on debt instruments such as bonds used to finance the installation of energy harvesting facilities 401. In one embodiment, the entity determines a total amount of energy 402 to generate/produce annually that covers all the energy consumption needs of end-customers and also includes a surplus amount of energy which may result in pure profit for the entity.

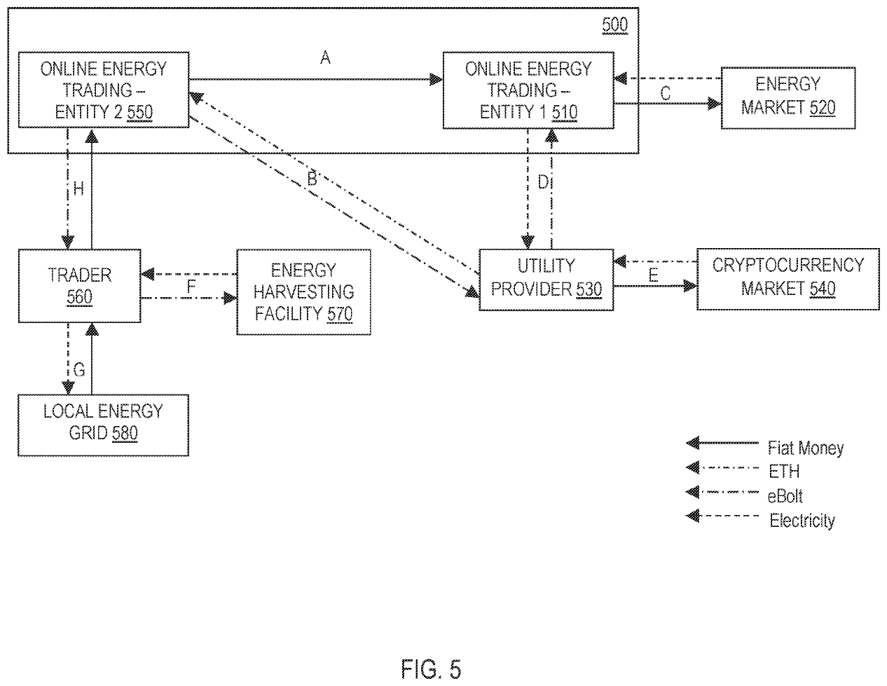

FIG. 5 illustrates an example distributed system 500, in accordance with an embodiment of the invention. In one embodiment, the distributed system 500 comprises different online energy trading platforms deployed for different geographical regions, such as a first online energy trading platform 510 for a first geographical region/territory (e.g., Europe) controlled/operated by a first entity Entity 1 (e.g., the Solar Generation—EU) and a second online energy trading platform 550 for a second geographical region/territory (e.g., USA) controlled/operated by a second entity Entity 2 (e.g., the Solar Generation—0 USA), as shown in FIG. 5. In one embodiment, each online energy trading platform is implemented using the system 200 in FIG. 1. The system 500 facilitates flow of different kinds of assets between different participants.

In one embodiment, an entity with ownership of the system 200 can license use of the technology to others. For example, if Entity 1 has ownership of the technology, Entity 2 pays a license fee in the form of fiat money to Entity 1 to use and operate the second online energy trading platform 550, as illustrated by reference label A in FIG. 5.

As illustrated by reference label B in FIG. 5, Entity 2 issues, via the second online energy trading platform 550, crypto commodity in the form of eBOLT tokens/credits to a utility provider 530, and receives, via the second online energy trading platform 550, crypto currency in the form of ETH from the utility provider 530 in exchange.

As illustrated by reference label C in FIG. 5, Entity 1 uses all the fiat money received from Entity 2 (reference label A) to purchase, via the first online energy trading platform 510, electricity from an energy market in the first geographical region (e.g., Nord Pool).

As illustrated by reference label D in FIG. 5, Entity 1 sells, via the first online energy trading platform 510, the electricity it purchased in step C to the utility provider 530, and receives, via the first online energy trading platform 510, crypto commodity in the form of eBOLT tokens/credits from the utility provider 530 in exchange.

As illustrated by reference label E in FIG. 5, the utility provider 530 exchanges fiat money (e.g., EUR) for cryptocurrency ETH with a cryptocurrency market 540 (e.g., Kraken) to pay for the eBOLT tokens/credits issued to it from Entity 1.

As illustrated by reference label F in FIG. 5, an energy harvesting facility 570 (e.g., a solar plant) sells electricity it generated to a trader 560, and receives eBOLT tokens/credits from the trader 560 in exchange.

As illustrated by reference label G in FIG. 5, the trader 560 sells the electricity it bought (reference label F) to a utility provider (e.g., Nevada Energy) operating a local energy grid 580, and receives fiat money (e.g., USD) from the utility provider in exchange.

As illustrated by reference label H in FIG. 5, Entity 2 issues, via the second online energy trading platform 550, crypto commodity in the form of eBOLT tokens/credits to the trader 560, and receives, via the second online energy trading platform 550, fiat money (e.g., USD) from the trader 560 in exchange.

As shown in FIG. 5, the flow of electricity within the local energy grid triggers a reciprocal reverse flow of eBOLT tokens/credits crypto commodity. As shown in FIG. 5, eBOLT tokens/credits are traded for ETH, which in turn is purchased on the cryptocurrency market 540 for fiat money (e.g., EUR).

In one embodiment, to utilize the system 200, utility providers and resellers pay a flat license fee (e.g., to Entity 1/Entity 2) per user and per month based on size of households it supplies power to and energy consumption profiles it manages.

For example, assume the energy harvesting facility 570 is a solar plant with PV panels producing 1 MWh electricity outside of Las Vegas, Nev.. The solar plant passes this energy to Entity 2 (e.g., the Solar Generation—USA) and receives 1 eBOLT token/credit in exchange. Entity 2 sells this electricity to a local energy grid and is paid in USD. The funds are then transferred to Entity 1 (e.g., the Solar Generation—EU), converted to EUR and used to buy 3 MWh of electricity at the Nord Pool market in Finland. This energy is then passed to a Balancing Group to supply end-customers. The Balancing Group pays 3 eBOLT tokens/credits to Entity 1 for this energy. The energy is distributed to consumers 305 and each of them pays in eBOLT tokens/credits for the energy it consumes.

To settle this transaction, the Balancing Group needs to buy eBOLT tokens/credits in advance. The Balancing Group does so using a market formed by a SaleOffer contract in which it chooses the best possible rate and drains offers available until it buys a desired total of 3 eBOLT tokens/credits. On the other end of this transaction are parties holding eBOLT tokens/credits who liquidize them for ETH. Using this mechanism, the solar plant which produced the energy is paid for electricity in ETH. It exchanges the eBOLT tokens/credits it received into ETH, which can later on be exchanged for fiat assets. However, as a result of a price arbitrage effect, the solar plant only gets one eBOLT token/credit, whereas 3 eBOLT tokens/credits are needed; this missing amount is provided by Entity 1/Entity 2 which publishes sale offers every day to keep the market liquid. The exchange rate of eBOLT/ETH is calculated every day on the basis of the current ETH/USD rate and the price of energy on the markets taking part in the trade.

In one embodiment, the distributed system 500 is utilized to power houses in Nordic countries (Finland, Sweden and Norway) using solar generation (i.e., solar production) in the US, wherein each solar plant owner in the US gets eBOLT tokens/credits in exchange for solar energy generated.

In one embodiment, the distributed system 500 can work in connection with different types of energy markets. For example, in one embodiment, the distributed system 500 works in connection with the Nordic Balance Settlement (NBS) model, a common balance settlement mechanism for the Nordic countries. The energy market in the Nordic countries is a deregulated market. Any company registered in the European Union (EU) can become an actor in the energy market by applying for certification. The price of energy is the result of trade on the wholesale market and adjusts dynamically in response to demand and supply volumes. Geographical regions are divided into multiple bidding areas. For example, Finland as a whole constitutes one bidding area, while Sweden is divided into 4 bidding areas.

Each actor in the energy market is identified by a corresponding Energy Identification Code (EIC). Actors can freely exchange energy between each other simply by informing a designated DSO.

One of the most important actors in the Nordic energy market is Nord Pool, an organization is in charge of running the bidding market for 15 European countries including the Nordic countries, UK, Germany and the Baltics. Among other things, Nord Pool operates a Day-Ahead Market (i.e., a financially-binding forward energy market) for customers and producers.

An energy supplier (e.g., Entity 1 or Entity 2 in FIG. 5) assumes the role of a Balance Responsible Party (BRP) in the energy market. BRPs are in charge of customer portfolios indicative of energy consumption needs of customers, wherein each customer portfolio is assigned to a specific bidding area. Within the NBS model, BRPs are responsible to provide enough energy to balance the consumption/production of their customer portfolios. The balance is calculated with the resolution of 1 hour.

It is solely up to the BRP to decide how to reach balance for the customer portfolios it manages. One way is to purchase a sufficient amount of energy on the open market (e.g., Nord Pool). Another is to self-produce the energy, by mixing energy generation into its customer portfolio along with consumption. Last, but not least, BRPs can trade energy bilaterally with other BRPs and retailers. In this case, it is completely up to the actors involved to decide the terms of such trade. The price of energy sold bilaterally is not regulated and may be passed on for free.

BRPs need to decide a day in advance how much energy to buy to supply their consumers. This is not an easy problem. Energy consumption depends on many factors, such as weather, bank holidays, local festivals, etc. They all need to be taken into account to match the order with the actual consumption. Failure to do so results in inefficient purchases/sales, therefore getting this part right is essential for maintaining positive margin on sales to the end-customer. Most utility companies outsource this responsibility to an external portfolio manager who has sufficient experience and historical data to run prediction models.

In the event that a BRP fails to provide enough energy to meet the energy consumption needs of the customer portfolios it manages, the BRP can automatically purchase the deficit on a regulated market from the DSO. Symmetrically, if a BRP has surplus energy for any given hour, the BRP can automatically sell the surplus energy on the regulated market. The prices on the regulated market change dynamically and are designed to penalize imbalances, but these penalties are not drastic. On average, buying energy on the regulated market is ˜20% more expensive than on the Day-Ahead Market. Selling energy on the regulated market is ˜10% less profitable than selling it on the Day-Ahead Market.

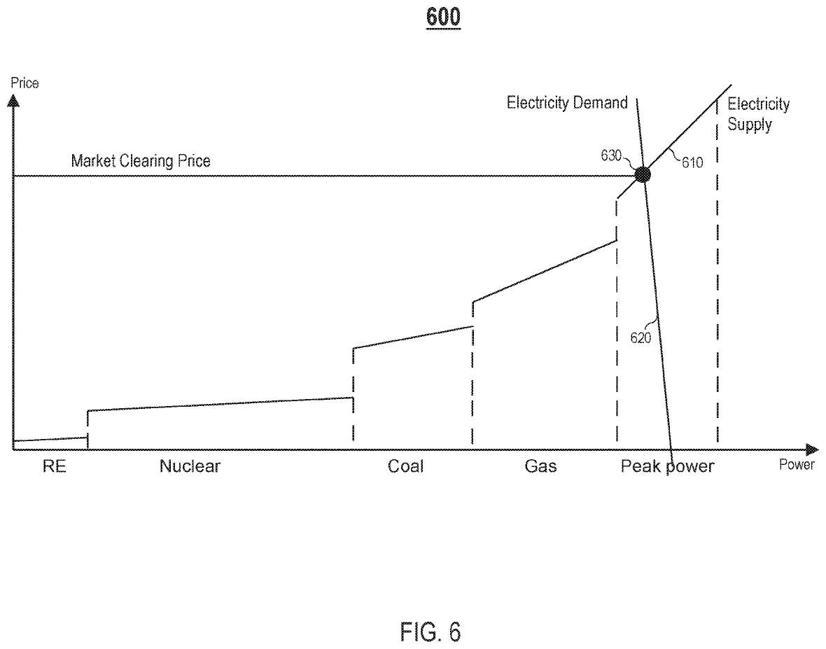

For Nord Pool, each participant places bids until the deadline of 12 a.m. CET, wherein each bid comprises the following information: how much energy is to be sold/bought and a range of acceptable prices per MWh. After the deadline, all the bids are calculated to decide the price of energy for each individual hour (i.e., hourly price) of the day ahead based on a merit order curve model 600 (FIG. 6), as described in detail later herein. Bids in which the price range includes the final calculated price are fulfilled. If the price is outside of a bid's range, the bid gets rejected. As prices are not known in advance, if a participant wants to sell/buy energy regardless of the price, the participant needs to put a very broad price range in its bid. The result of trade is published by 2 p.m. CET every day. This leaves enough time for the operators of energy harvesting facilities 570 to plan.

FIG. 6 is an example merit order curve model 600. The merit order curve model 600 is used to calculate hourly price for energy, wherein the price is a function of electricity supply and electricity demand. The merit order curve model 600 includes a first line 610 representing electricity supply and a second line 620 representing electricity demand. An hourly price for energy is decided by sorting producer bids in order of minimum price request, with the lower priced bids considered first. As electricity demand increases, higher priced bids are fulfilled, as shown in FIG. 6. An intersection 630 of the lines 610 and 620 represents a market clearing price for energy for all market participants (i.e., every energy harvesting facility 570 receives this same price for its energy generated, regardless of operating costs).

The merit order curve model 600 is designed to incentivize pushing down costs of producing energy. For years, it has been a driving force of innovation and investment in renewable energy sources. As generation of renewable energy has low operating costs, energy harvesting facilities 570 are likely to have their bids matched. Additionally, generation of renewable energy provides the best return on investment (ROI) per MWh.

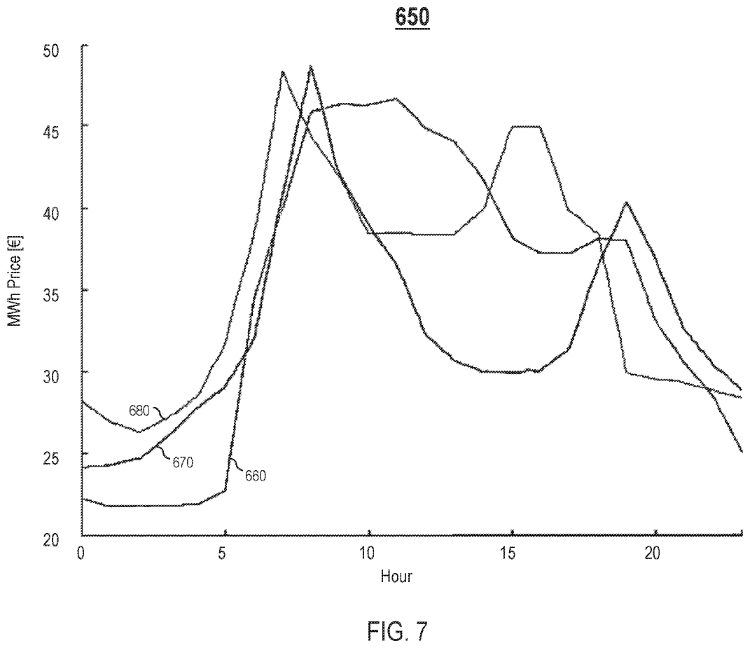

FIG. 7 is an example graph 650 illustrating Day-Ahead Market prices. As stated above, for Nord Pool, price for energy is dynamic and set for every hour. The graph 650 includes the followings a first curve 660 representing a daily cycle of price fluctuations on a first weekday in Finland, a second curve 670 representing a daily cycle of price fluctuations on a second weekday in Finland, and a third curve 680 representing a daily cycle of price fluctuations on a third weekday in Finland. As shown in FIG. 7, on a weekday there are typically two price spikes/peaks: (1) a first price spike occurs between 8 a.m. to 10 a.m. when people wake up and prepare for work, and (2) a second price spike between 4 p.m. and 6 p.m. when people come back home, cook dinner, etc. The particular hour of a price spike depends on the season and is fairly predictable. This trend/pattern is clearly observable during weekdays. Weekend and holiday days have much lower variety of energy prices, but still a milder repeatable trend can be seen.

In one embodiment, an energy forecast system 350 deployed in a consumer environment 300 is configured to charge one or more battery storage systems 320 maintained in the consumer environment 300 in advance of when price spikes will occur, thereby passing on significant savings to a consumer 305.

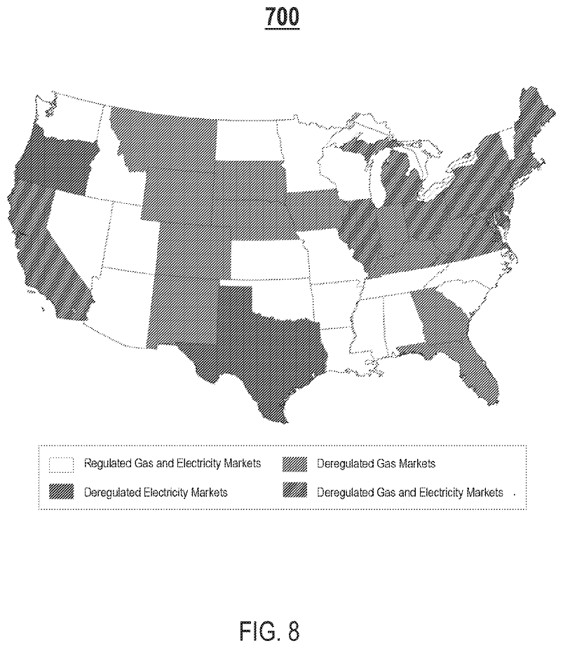

As another example, in one embodiment, the distributed system 500 works in connection with regulated energy markets and deregulated energy markets in the US. FIG. 8 is an example map 700 illustrating regulated energy markets and deregulated energy markets in the US. The energy market in the US is a prerogative of state governments, not the federal government. Currently, no state in the US has an energy market that is completely deregulated. In Texas, approximately 85% of the state has access to energy choice. By comparison, the energy market in Nevada is regulated. Corporations willing to operate on the energy market in Nevada have to apply to the Nevada Energy Commission for a license. Operators of energy harvesting facilities 570 are only allowed to sell the energy it generates to the state operator of Nevada. A feed-in tariff depends on a location of an energy harvesting facility 570 and is agreed with the state operator upfront. Unlike the Nordic Balance Settlement model, the price for energy is fixed and does not vary throughout the day.

Currently in the US, there is neither a mechanism to promote competition between energy harvesting facilities 570 nor an incentive to push down operating costs. As such, there are large economic imbalances between the energy markets in the Nordic countries and the US. For example, the price for energy in the US is significantly higher than in Nordic countries. An estimated average energy contract in Nevada is $100 per MWh for households, which is about 2.5 times more than what the price is in Finland.

In one embodiment, the system 200 can be used to exploit these economic imbalances using financial markets. The system 200 can be used to supply consumers in the Nordic countries with 100% energy (e.g., solar power) by re-locating some energy generation from the Nordic countries to locations optimized for energy generation, such as California or Nevada. Energy produced in the US is sold to state operators or home owners in deregulated markets. Money earned from this energy production is used to buy energy from NordPool that is then supplied to consumers in the Nordic countries. One potential financial effect may result from this exchange in which an amount/volume of energy exchanged is multiplied by a price arbitrage factor, which is a consequence of differences in prices.

For example, over a year, a US residential household located in a geographical location with a high solar index receives about 345 Watts/m² of sunlight energy per square meter, whereas a residential household in Finland only receives about 235 Watts/m². This difference renders an additional factor of 1.46, which combined with a price difference between a US residential household paying $0.20 USD per kWh, per a bilateral power purchase agreement (PPA), to buying wholesale energy in Finland, via Nord Pool, at $0.035 factor results in a total coefficient of 15. Therefore, re-locating some energy generation from the Nordic countries to the US makes it more effective by the factor of 15, in turn increasing a likelihood of producing enough energy to fulfill all end-customers' consumption needs.

Returning to FIG. 3A, in one embodiment, an arbitrage unit 357 of an energy forecast system 350 is configured to: (1) forecast energy prices on a Day-Ahead Market (e.g., a Day-Ahead Market for Nord Pool), (2) determine a daily plan for maximizing a volume of energy to purchase from a local energy grid during the hours when energy prices are cheaper, and unloading/selling energy during the hours when energy prices are higher (e.g., at its peak), (3) adjust the daily plan based on forecasts of energy consumption needs and energy production obtained from the energy consumption unit 351 and the energy production unit 354, respectively, and (4) generate bids based on the adjusted daily plan, wherein the bids are submitted to the Day-Ahead Market in advance (e.g., before the day starts). Later, during the day, the energy forecast system 350 controls the battery storage systems 320 in accordance with the daily plan (e.g., charging, discharging or turning off via the storage control unit 359).

In one embodiment, the energy forecast system 350 is configured to perform corrective measures in response to real energy production or real energy consumption needs diverging too far from daily commitments of a BRP. For example, in one embodiment, the energy forecast system 350 is configured to adjust a daily plan dynamically to converge it back into balance.

In one embodiment, the energy forecast system 350 is configured to allocate 80% of a battery capacity of a battery storage system 320 for price arbitrage, and a remaining 20% for other purposes. For example, if a battery capacity of a battery storage system 320 is 9,68 kWh, the amount of battery capacity available for price arbitrage is 7,74 kWh.

In one embodiment, the price arbitrage model 358 utilized by the arbitrage unit 357 implements the following: battery storage systems 320 are charged up during the night and midday, and discharged during daily peak energy consumption demand. The energy forecast system 350 is configured to optimize battery capacity of the battery storage systems 320 based on the price arbitrage model 358. For example, in one embodiment, €53 yearly profit for a battery storage system 320 results from use of the price arbitrage model 358, wherein the profit is solely the result of price arbitrage.

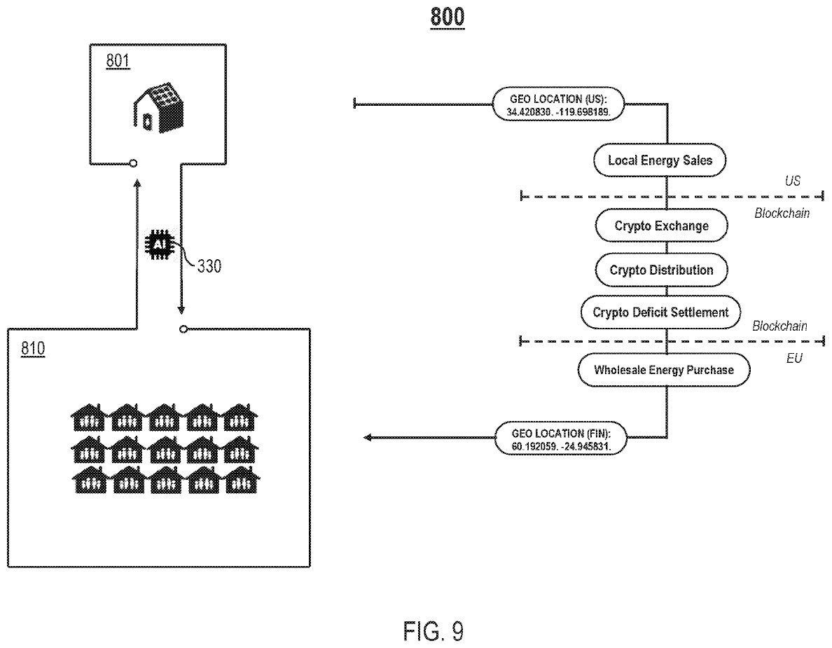

FIG. 9 illustrates an example business model 800 for trading energy between participants located in different geographical locations utilizing the system 200, in accordance with an embodiment of the invention. For example, in one embodiment, the business model 800 includes the following participants: (1) one consumer 801 located in a first geographical location with a high solar index (e.g., a US residential household located in California, Nev., etc.), wherein the first consumer 801 has a bilateral PPA, and (2) a group of consumers 810 located in a second geographical location (e.g., a balancing group comprising fifteen residential households located in the Nordic countries), wherein the group of consumers 810 pay a monthly subscription flat fee. Each consumer 801, 810 has its own AI smart device 330 with the energy forecast system 350 integrated/embedded in the device 330 for forecasting energy production, forecasting energy consumption, managing smart contracts, managing energy surplus/deficit, managing crypto commodity and energy settlement on the system 200, and managing grid trade (i.e., trading energy with a local energy grid).

The business model 800 facilitates energy trades between the participants. For example, as shown in FIG. 9, assume the consumer 801 locally produces energy utilizing one or more energy production units 310 (e.g., PV panels). The consumer 801 sells some of the energy produced to local entities (“local energy sales”), such as state operators, etc., via its own AI smart device 330. Money earned from the energy production is used to buy energy from Nord Pool (“wholesale energy purchase”) that is then supplied to the group of consumers 810. The business model 800 utilizes the system 200 for crypto exchange (i.e., exchange of crypto commodities, such as exchange of eBOLT tokens/credits, exchange of eBOLT tokens/credits for ETH on the Ethereum blockchain, etc.), crypto distribution (i.e., distribution of crypto commodities, such as issue/sale of eBOLT tokens/credits, etc.), and crypto deficit settlement (i.e., settlement of deficits using crypto commodities, such as balancing energy consumption needs of the group of consumers 810 utilizing crypto commodities).

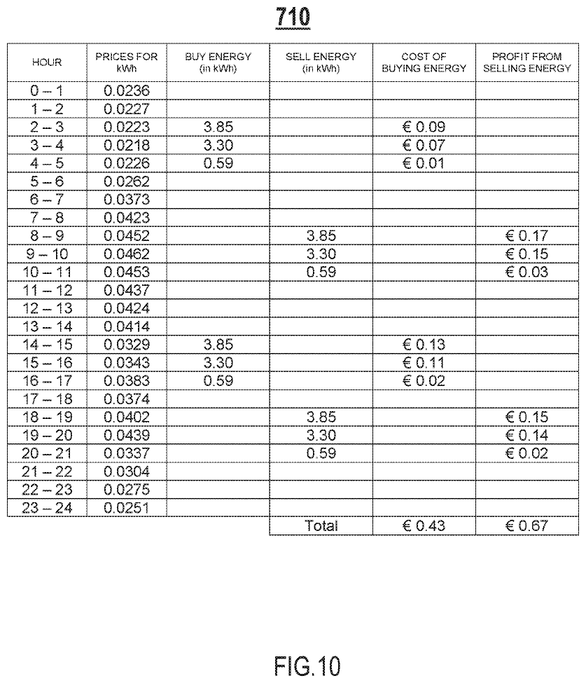

FIG. 10 illustrates an example table 710 illustrating performance of a price arbitrage model using historical prices for the Finnish market in April 2017, in accordance with an embodiment of the invention. As shown in Table 710, the hourly prices are the average calculated for all the weekdays taken for the month of April 2017. The model renders a daily profit of €0.24. In Table 1 you can see an example of using the price arbitrage method for an average day in April 2017. The same amount of energy has been bought and sold during a 24-hour period, however, thanks to the discrepancy in prices at different hours, a profit of €0,24 was achieved. With a properly built system, profit can be achieved every day during the year and in total provides a noticeable difference.

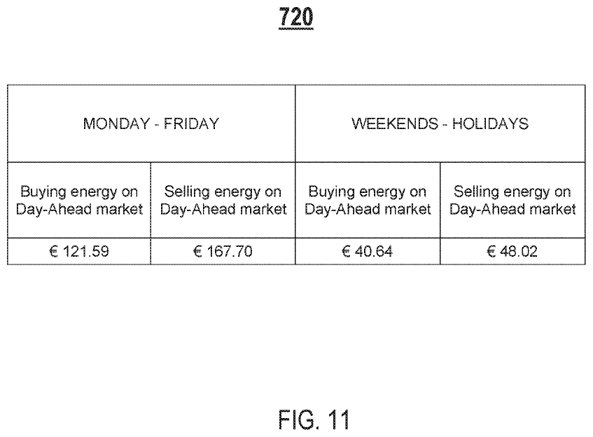

FIG. 11 illustrates an example table 720 illustrating differences between yearly cost of the same amount of energy bought and sold during lowest and highest peaks on weekdays and weekends, in accordance with an embodiment of the invention. Applying (i.e., running) the price arbitrage model run on historical prices for the Finnish market renders a profit of €53,49 for a full year. Most of this profit is made on weekdays. Holidays bring a smaller but positive contribution. It is important to note that the result of €53 is equivalent to about 1,6 MWh of electricity bought for the average market price. Just by having an AI smart device 330 control home batteries in a household (i.e., battery storage systems 320), solar generation gets 12% of the yearly energy needs of the household for free.

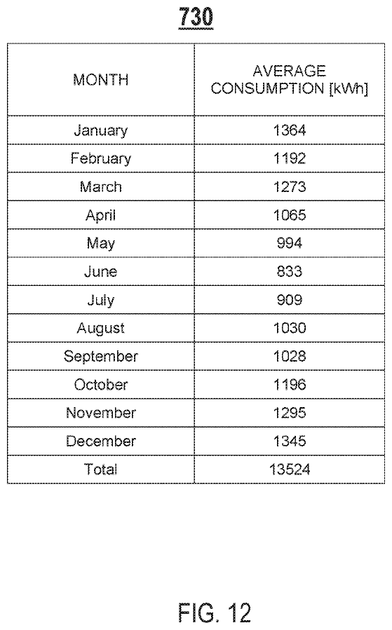

FIG. 12 illustrates an example table 730 illustrating an average energy consumption profile of an average residential household in Helsinki, in accordance with an embodiment of the invention. An average residential household in Helsinki has a yearly usage of about 13,500 kWh of electricity. As shown in FIG. 12, the consumption of electricity is the highest in the winter months when the days are short and people typically use electric heating and saunas.

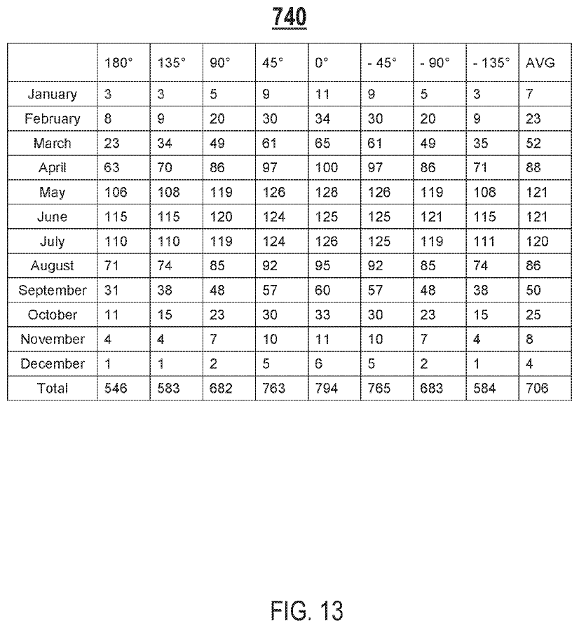

FIG. 13 illustrates an example table 740 illustrating an average energy production profile of a PV installation on a rooftop of a residential household that is configured to produce 1 kWp, in accordance with an embodiment of the invention. The table 740 provides a monthly breakdown of energy production per geometrical orientation on the rooftop, and a monthly average weighted per assumed distribution of orientations. For example, in one embodiment, 50% of PV panels will be at a −45/0/45° orientation, 30% will be at −90/90°, and only 20% will be at −135/180/135°.

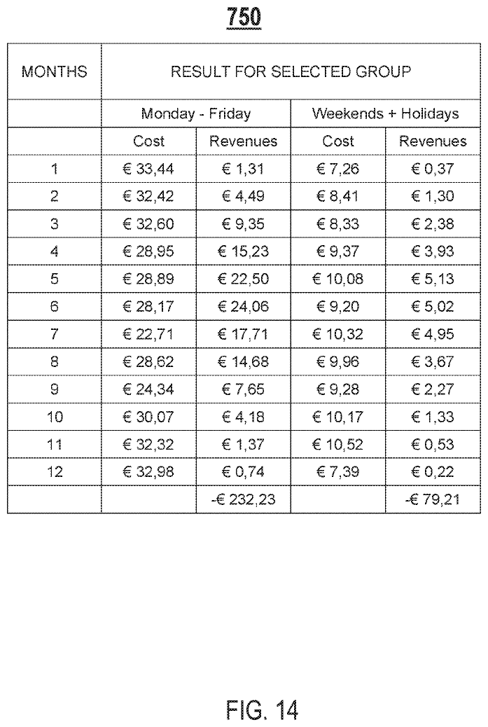

FIG. 14 illustrates an example table 750 illustrating balance of cost and revenues for an average residential household in Helsinki with a PV installation with a combined nominal power of 6,09 kWp, in accordance with an embodiment of the invention. In one embodiment, assume the PV installation is installed on a rooftop of a residential household with averaged out orientation (e.g., requires 36 m² of available space on the rooftop). The values included in the table 750 are calculated using historical prices for each month on the Finnish Day-Ahead Market for the time period 2016-2017. As shown in FIG. 14, there are differences between the use of energy during weekdays and free days like weekends and holidays. During the year, around 300 EUR in total needs to be covered from a different source; this amount can be earned by selling energy, such as on a regulated market in Nevada.

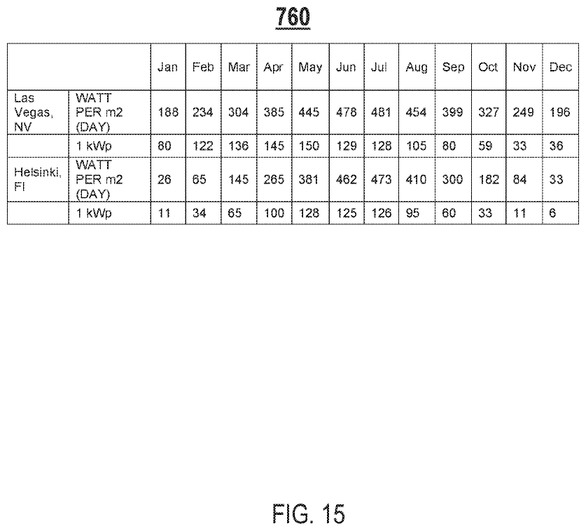

FIG. 15 illustrates an example table 760 illustrating difference in performance of a PV installation with nominal power of 1 kWp in Las Vegas and Helsinki, in accordance with an embodiment of the invention. In one embodiment, to accomplish the goal of fully powering Scandinavian households with solar power, PV installations are installed in another geographical region, such as Nevada. As shown in FIG. 15, a PV installation with nominal power of 1 kWp in Las Vegas produces 1,200 kWh of power per year. Installation of nominal power of 2.1 kWp is sufficient to account for the power needed by an average residential household in Helsinki.

One MWh or power in Helsinki costs about €32, but in Las Vegas, selling one MWh of power yields €90. As a result of price arbitrage, one MWh of power produced and sold in Nevada will yield three MWh of power in Finland. Therefore, to power an average residential household in Helsinki, the residential household needs 21 PV panels installed on its rooftop and 10 additional PV panels in Nevada to produce enough power to cover its yearly power demand.

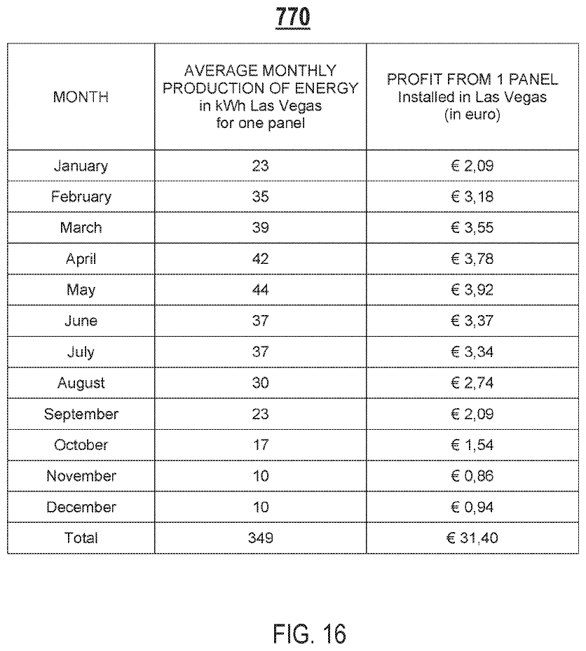

FIG. 16 illustrates an example table 770 illustrating average monthly energy production of a PV installation in Las Vegas and profits that can be earned from the PV installation, in accordance with an embodiment of the invention. As shown in FIG. 16, it is possible to gain approximately €31 per year from one PV installation. Therefore, to cover €310, an additional 10 panels need to be installed.

In one embodiment, the system 200 utilizes meter smart contracts. A meter smart contract mimics standard energy meters and stores on the blockchain a meter value representing an all-time sum of energy consumption. In one embodiment, every participant of the system 200 is identified by an Ethereum address such that energy trade is point-to-point (e.g., can specify two addresses representing a source and a target of the flow of energy). When a meter value of a meter smart contract increases, a flow of eBOLT tokens/credits from a source address to a target address is automatically triggered, wherein the amount flowing is equal to the amount of MWh by which the meter value was increased.

In one embodiment, each consumer environment 300 has two meter values: one for energy consumption, and one for energy production.

If a consumer 305 does not have enough eBOLT tokens/credits to cover flow of energy (e.g., a newly connected residential household), a source address can automatically take an eBOLT loan from a target address for the debt. The target address can only borrow eBOLT tokens/credits if it has sufficient balance to cover the debt. Debts are settled automatically by the on-chain mechanism of the meter smart contract when the debtor receives eBOLT tokens/credits.

A balancing group represents all consumers 305 and potential consumers arranged into a portfolio, wherein the portfolio's daily balance of energy may be positive or negative. If the balance is negative, the balancing group consumes more energy during the day than it produces. In such a case, the balancing group buys the missing energy (e.g., from the Solar Generation); this trade can be settled using eBOLT tokens/credits with a fixed ratio of 1 MWh for one eBOLT token/credit.

In one embodiment, the system 200 settles energy trade between all participants in eBOLT tokens/credits. eBOLT tokens/credits are bought through the on-chain open market and settled in ETH. In one embodiment, the system 200 autonomously buys ETH for each balancing group through a configured Kraken account.

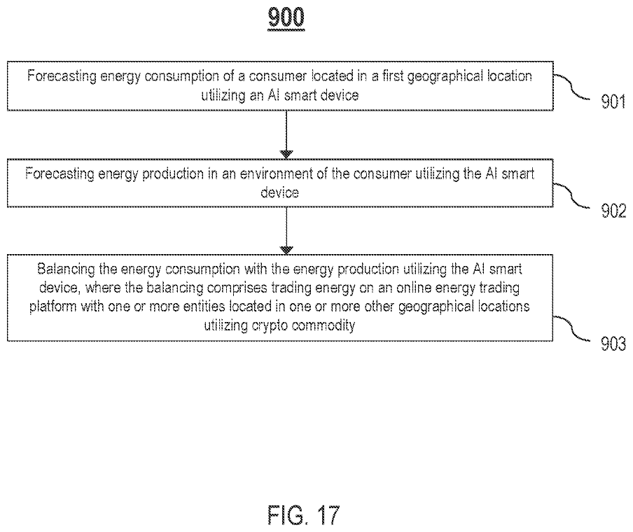

FIG. 17 is a flowchart for an example process 900 for implementing a vertical global energy online trading platform, in accordance with an embodiment of the invention. Process block 901 includes forecasting energy consumption of a consumer located in a first geographical location utilizing an AI smart device (e.g., AI smart device 330). Process block 902 includes forecasting energy production in an environment of the consumer utilizing the AI smart device. Process block 903 includes balancing the energy consumption with the energy production utilizing the AI smart device, wherein the balancing comprises trading energy on an online energy trading platform with one or more entities located in one or more other geographical locations utilizing crypto commodity.

In one embodiment, process blocks 901-903 are performed by one or more components of the AI smart device 330, such as the energy forecast system 350.

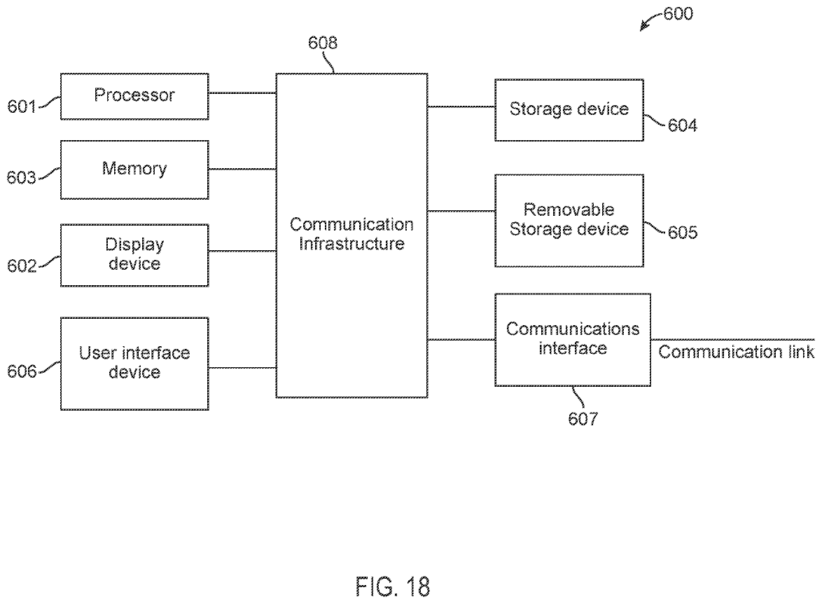

FIG. 18 is a high-level block diagram showing an information processing system comprising a computer system 600 useful for implementing the disclosed embodiments. The computer system 600 includes one or more processors 601, and can further include an electronic display device 602 (for displaying video, graphics, text, and other data), a main memory 603 (e.g., random access memory (RAM)), storage device 604 (e.g., hard disk drive), removable storage device 605 (e.g., removable storage drive, removable memory module, a magnetic tape drive, optical disk drive, computer readable medium having stored therein computer software and/or data), viewer interface device 606 (e.g., keyboard, touch screen, keypad, pointing device), and a communication interface 607 (e.g., modem, a network interface (such as an Ethernet card), a communications port, or a PCMCIA slot and card). The communication interface 607 allows software and data to be transferred between the computer system and external devices. The system 600 further includes a communications infrastructure 608 (e.g., a communications bus, cross-over bar, or network) to which the aforementioned devices/modules 601 through 607 are connected.

Information transferred via communications interface 607 may be in the form of signals such as electronic, electromagnetic, optical, or other signals capable of being received by communications interface 607, via a communication link that carries signals and may be implemented using wire or cable, fiber optics, a phone line, a cellular phone link, an radio frequency (RF) link, and/or other communication channels. Computer program instructions representing the block diagram and/or flowcharts herein may be loaded onto a computer, programmable data processing apparatus, or processing devices to cause a series of operations performed thereon to generate a computer implemented process. In one embodiment, processing instructions may be stored as program instructions on the memory 603, storage device 604, and/or the removable storage device 605 for execution by the processor 601.

Embodiments have been described with reference to flowchart illustrations and/or block diagrams of methods, apparatus (systems) and computer program products. Each block of such illustrations/diagrams, or combinations thereof, can be implemented by computer program instructions. The computer program instructions when provided to a processor produce a machine, such that the instructions, which execute via the processor create means for implementing the functions/operations specified in the flowchart and/or block diagram. Each block in the flowchart /block diagrams may represent a hardware and/or software module or logic. In alternative implementations, the functions noted in the blocks may occur out of the order noted in the figures, concurrently, etc.

The terms “computer program medium,” “computer usable medium,” “computer readable medium”, and “computer program product,” are used to generally refer to media such as main memory, secondary memory, removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

As will be appreciated by one skilled in the art, aspects of the embodiments may be embodied as a system, method or computer program product. Accordingly, aspects of the embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the embodiments may take the form of a computer program product embodied in one or more computer readable medium(s) having computer readable program code embodied thereon.

Any combination of one or more computer readable medium(s) may be utilized. The computer readable medium may be a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code for carrying out operations for aspects of one or more embodiments may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of one or more embodiments are described above with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. section 112, sixth paragraph, unless the element is expressly recited using the phrase “means for” or “step for.”

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the embodiments has been presented for purposes of illustration and description, but is not intended to be exhaustive or limited to the embodiments in the form disclosed. Many modifications and variations will be apparent to those of ordinary skill in the art without departing from the scope and spirit of the invention.

Though the embodiments have been described with reference to certain versions thereof; however, other versions are possible. Therefore, the spirit and scope of the appended claims should not be limited to the description of the preferred versions contained herein.

1. A method comprising:
at an artificial intelligence (AI) smart device:
receiving, via one or more sensor units, context information related to an environment of a consumer located in a first geographical location;
forecasting energy consumption of the consumer based in part on the context information;
forecasting energy production of one or more energy production units in the environment of the consumer based in part on the context information; and
balancing the energy consumption with the energy production, wherein the balancing comprises:
forecasting energy prices on a Day-Ahead Market;
determining a daily plan based on the energy prices, the energy consumption, and the energy production, wherein the daily plan is indicative of one or more hours of a day to purchase extra energy to meet the energy consumption, and the daily plan is further indicative of one or more other hours of the day to sell surplus energy produced by the one or more energy production units; and
based on the daily plan, generating and submitting one or more electronic bids to the Day-Ahead Market in advance to autonomously purchase the extra energy during the one or more hours of the day from, and sell the surplus energy during the one or more other hours of the day to, one or more entities located in one or more other geographical locations different than the first geographical location.

2. The method of claim 1, wherein the balancing comprises:
selling the surplus energy during the one or more other hours of the day to the one or more entities on an online energy trading platform utilizing crypto commodity in response to the energy production exceeding the energy consumption.

3. The method of claim 2, wherein the balancing comprises:
purchasing the extra energy during the one or more hours of the day from the one or more entities on the online energy trading platform utilizing the crypto commodity in response to the energy consumption exceeding the energy production.

4. The method of claim 1, wherein the one or more energy production units includes one or more installations of photovoltaic (PV) panels for production of solar energy.

5. The method of claim 1, wherein the context information comprises at least one of: location coordinates of the first geographical location, a video capture or a photograph of the environment, ambient noise of the environment, a temperature of the environment, time of day, day of the week, public holidays, a meter value of energy consumption in the environment, a meter value of energy production in the environment, weather of the environment, nominal power of the one or more energy production units, and geometrical roof orientation in the environment.

6. The method of claim 3, wherein the crypto commodity comprises one or more eBOLT tokens.

7. The method of claim 6, wherein each eBOLT token is exchangeable for Ether (ETH) cryptocurrency.

8. The method of claim 1, wherein the balancing comprises:
in response to the energy consumption exceeding the energy production, generating and submitting a first electronic bid to the Day-Ahead Market in advance of the day to purchase the extra energy during the one or more hours of the day from the one or more entities, wherein the energy prices are lower during the one or more hours of the day compared to another hour of the day; and
in response to the energy production exceeding the energy consumption, generating and submitting a second electronic bid to the Day-Ahead Market in advance of the day to sell the surplus energy during the one or more other hours of the day to the one or more entities, wherein whcn the energy prices are higher during the one or more other hours of the day compared to another hour of the day.

9. The method of claim 8, wherein the balancing comprises:
controlling operation of one or more battery storage systems in the environment of the consumer based on the daily plan, wherein the controlling comprises:
in response to the energy production exceeding the energy consumption, triggering the one or more battery storage systems to charge a battery capacity of the one or more battery storage systems with the surplus energy if one of the following conditions occurs: the surplus energy is not successfully sold during the one or more other hours of the day, or the energy prices are lower compared to another hour of the day; and
in response to the energy consumption exceeding the energy production, triggering the one or more battery storage systems to discharge the extra energy from the battery capacity of the one or more battery storage systems if one of the following conditions occurs: the extra energy is not successfully purchased during the one or more hours of the day, or the energy prices are higher compared to another hour of the day.

10. A system comprising:
a memory device configured to store instructions; and
at least one hardware processor configured to execute the instructions including:
receiving, via one or more sensor units, context information related to an environment of a consumer located in a first geographical location;
forecasting energy consumption of the consumer based in part on the context information;
forecasting energy production of one or more energy production units in the environment of the consumer based in part on the context information; and
balancing the energy consumption with the energy production, wherein the balancing comprises:
forecasting energy prices on a Day-Ahead Market;
determining a daily plan based on the energy prices, the energy consumption, and the energy production, wherein the daily plan is indicative of one or more hours of a day to purchase extra energy to meet the energy consumption, and the daily plan is further indicative of one or more other hours of the day to sell surplus energy produced by the one or more energy production units; and
based on the daily plan, generating and submitting one or more electronic bids to the Day-Ahead Market in advance to autonomously purchase the extra energy during the one or more hours of the day from, and sell the surplus energy during the one or more other hours of the day to, one or more entities located in one or more other geographical locations different than the first geographical location.

11. The system of claim 10, wherein the balancing comprises:
selling the surplus energy during the one or more other hours of the day to the one or more entities on an online energy trading platform utilizing crypto commodity in response to the energy production exceeding the energy consumption.

12. The system of claim 11, wherein the balancing comprises:
purchasing the extra during the one or more hours of the day from the one or more entities on the online energy trading platform utilizing the crypto commodity in response to the energy consumption exceeding the energy production.

13. The system of claim 10, wherein the one or more energy production units includes one or more installations of photovoltaic (PV) panels for production of solar energy.

14. The system of claim 10, wherein the context information comprises at least one of: location coordinates of the first geographical location, a video capture or a photograph of the environment, ambient noise of the environment, a temperature of the environment, time of day, day of the week, public holidays, a meter value of energy consumption in the environment, a meter value of energy production in the environment, weather of the environment, nominal power of the one or more energy production units, and geometrical roof orientation in the environment.

15. The system of claim 12, wherein the crypto commodity comprises one or more eBOLT tokens.

16. The system of claim 15, wherein each eBOLT token is exchangeable for Ether (ETH) cryptocurrency.

17. The system of claim 10, wherein the balancing comprises:
in response to the energy consumption exceeding the energy production, generating and submitting a first electronic bid to the Day-Ahead Market in advance of the day to purchase the extra energy during the one or more hours of the day from the one or more entities, wherein the energy prices are lower during the one or more hours of the day compared to another hour of the day; and
in response to the energy production exceeding the energy consumption, generating and submitting a second electronic bid to the Day-Ahead Market in advance of the day to sell the surplus energy during the one or more other hours of the day to the one or more entities, wherein the energy prices are higher during the one or more other hours of the day compared to another hour of the day.

18. The system of claim 17, wherein the balancing comprises:
controlling operation of one or more battery storage systems in the environment of the consumer based on the daily plan, wherein the controlling comprises:
in response to the energy production exceeding the energy consumption, triggering the one or more battery storage systems to charge a battery capacity of the one or more battery storage systems with the surplus energy if one of the following conditions occurs: the surplus energy is not successfully sold during the one or more other hours of the day, or the energy prices are lower compared to another hour of the day; and
in response to the energy consumption exceeding the energy production, triggering the one or more battery storage systems to discharge the extra energy from the battery capacity of the one or more battery storage systems if one of the following conditions occurs: the extra energy is not successfully purchased during the one or more hours of the day, or the energy prices are higher compared to another hour of the day.

19. A computer program product comprising a computer readable storage device having program instructions embodied therewith, the program instructions readable by a processor device to cause the processor device to:
receive, via one or more sensor units, context information related to an environment of a consumer located in a first geographical location;
forecast energy consumption of the consumer based in part on the context information;
forecast energy production of one or more energy production units in the environment of the consumer based in part on the context information; and
balance the energy consumption with the energy production by:
forecasting energy prices on a Day-Ahead Market;
determining a daily plan based on the energy prices, the energy consumption, and the energy production, wherein the daily plan is indicative of one or more hours of a day to purchase extra energy to meet the energy consumption, and the daily plan is further indicative of one or more other hours of the day to sell surplus energy produced by the one or more energy production units; and
based on the daily plan, generating and submitting one or more electronic bids to the Day-Ahead Market in advance to autonomously purchase the extra energy during the one or more hours of the day from, and sell the surplus energy during the one or more other hours of the day to, one or more entities located in one or more other geographical locations different than the first geographical location.

20. The computer program product of claim 19, wherein the balancing comprises:
selling the surplus energy during the one or more other hours of the day to the one or more entities on an online energy trading platform utilizing crypto commodity in response to the energy production exceeding the energy consumption; and
purchasing the extra energy during the one or more hours of the day from the one or more entities on the online energy trading platform utilizing the crypto commodity in response to the energy consumption exceeding the energy production.
